(19) United States
(12) Patent Application Publication
(10) Pub. No.: US 2026/0016867 A1
(43) Pub. Date: Jan. 15, 2026

(54) FOLDABLE ELECTRONIC DEVICE

(71) Applicant: SYNCMOLD ENTERPRISE CORP., New Taipei City (TW)

(72) Inventors: Ching-Hui YEN, New Taipei City (TW); Chien-Cheng YEH, New Taipei City (TW); Chun-Hao HUANG, New Taipei City (TW)

(21) Appl. No.: 19/212,804

(22) Filed: May 20, 2025

Related U.S. Application Data
(60) Provisional application No. 63/670,373, filed on Jul. 12, 2024.

(30) Foreign Application Priority Data
Mar. 26, 2025 (TW) 114111366

(51) Int. Cl. G06F 1/16

(52) U.S. Cl. CPC G06F 1/1681; G06F 1/1652

(57) ABSTRACT

The present invention provides a foldable electronic device which is capable of changing between an unfolded state, a half-open state, and a folded state and comprises a central base, a synchronous pivot module, a first operating module, a first panel unit, a second operating module, a second panel unit, an elastic module and a flexible screen. The central base includes a main portion. The synchronous pivot module includes a first shaft and a second shaft respectively penetrating through the main portion. The first operating module is connected to the synchronous pivot module and includes a first wing member which is able to pivot relative to the main portion, a first driving member which is sleeved on the first shaft, and a first connecting rod member which is pivoted on the first wing member and has a first straight sliding groove for the first driving member to slide and to insert therein. The first panel unit is connected to and capable of rotating synchronously with the first wing member. The second operating module is connected to the synchronous pivot module and includes a second wing member which is able to pivot relative to the main portion, a second driving member which is sleeved on the second shaft, and a second connecting rod member which is pivoted on the second wing member and has a second straight sliding groove for the second driving member to slide and to insert therein. The second panel unit is connected to and capable of rotating synchronously with the second wing member.

### CROSS REFERENCE TO RELATED APPLICATION

This application claims the benefit of U.S. Provisional Application Ser. No. 63/670,373 filed on Jul. 12, 2024, and the benefit of Taiwan Patent Application Serial No. 114111366 filed on Mar. 26, 2025. The entirety of each Application is incorporated herein by reference.

### BACKGROUND OF THE INVENTION

### 1. Field of the Invention

The present invention relates to a foldable electronic device, especially to a foldable electronic device with a four-bar linkage foldable hinge.

### 2. Description of Related Art

In recent years, due to vigorously developing of foldable electronic devices, various designs of foldable hinges have been continuously introduced therein. For example, TWM664632 discloses a foldable hinge that achieves synchronously rotating through a principle of a scotch yoke synchronization mechanism and works with a linkage and sliding mechanism to create an accommodation space for a flexible screen in a folded state. Another example, TWM652832 discloses another foldable hinge that achieves synchronously rotating through gears and generates an accommodation space for a flexible screen in a folded state by another type of linkage mechanism. The present invention provides an alternative design applying a seesaw-type operation to achieve similar effects.

### SUMMARY OF THE INVENTION

To achieve the above-mentioned objective, the present invention discloses a foldable electronic device, which comprises a central base, a synchronous pivot module, a first operating module, a first panel unit, a second operating module, a second panel unit, an elastic module and a flexible screen. The central base includes a main portion, a first front arc-shaped groove and a second front arc-shaped groove, and the first front arc-shaped groove and the second front arc-shaped groove are formed oppositely in the main portion. The synchronous pivot module is disposed in the central base and includes a first shaft and a second shaft respectively penetrating through the main portion. Wherein the first shaft extends along a first axis and the second shaft extends along a second axis. The first operating module is connected to the synchronous pivot module and includes a first wing member, a first driving member and a first connecting rod member. The first wing member has a first front arc-shaped block, and the first front arc-shaped block is rotatably disposed in the first front arc-shaped groove, so that the first wing member is able to pivot relative to the main portion. The first driving member is sleeved on the first shaft and capable of rotating relative to the first shaft around the first axis. The first connecting rod member has a first rod body and a first straight sliding groove formed in the first rod body. Wherein the first rod body is pivoted on the first wing member along a first rotation axis substantially parallel to the first axis, and the first straight sliding groove extends substantially perpendicular to the first axis for the first driving member to slide and to insert therein. The first panel unit is connected to and capable of rotating synchronously with the first wing member. The second operating module is connected to the synchronous pivot module and includes a second wing member, a second driving member and a second connecting rod member. The second wing member has a second front arc-shaped block, and the second front arc-shaped block is rotatably disposed in the second front arc-shaped groove, so that the second wing member is able to pivot relative to the main portion. The second driving member is sleeved on the second shaft and capable of rotating relative to the second shaft around the second axis. The second connecting rod member has a second rod body and a second straight sliding groove formed in the second rod body. Wherein the second rod body is pivoted on the second wing member along a second rotation axis substantially parallel to the second axis, and the second straight sliding groove extends substantially perpendicular to the second axis for the second driving member to slide and to insert therein. The second panel unit is connected to and capable of rotating synchronously with the second wing member. The elastic module is disposed in the central base, constantly provides a total elastic force to the first driving member and second driving member, and has an abutting member, a fixed seat, a first elastic member and a second elastic member. Wherein the abutting member is slidably sleeved on the first shaft and second shaft and is movably engaged with the first driving member and the second driving member, the fixed seat is fixed to the first shaft and second shaft, the first elastic member is sleeved on the first shaft, the second elastic member is sleeved on the second shaft, and the first elastic member and the second elastic member are respectively connected to the abutting member and the fixed seat respectively. The flexible screen is arranged on the central base, the first operating module, the first panel unit, the second operating module and the second panel unit, and includes a bendable area. Wherein the first panel unit and second panel unit are capable of changing between an unfolded state, a half-open state and a folded state, and the half-open state is between the unfolded state and the folded state. When the first panel unit and the second panel unit are in the unfolded state, the flexible screen is flattened, and the first wing member and the second wing member jointly support the bendable area. And when the first panel unit and the second panel unit are in the folded state, the bendable area of the flexible screen bends, and the first wing member, the second wing member and the central base jointly define an accommodating space for accommodating the bendable area.

In one embodiment, the first connecting rod member is centrally pivoted on the first wing member and is capable of performing a seesaw motion relative to the first wing member, and the second connecting rod member is centrally pivoted on the second wing member and is capable of performing a seesaw motion relative to the second wing member.

In one embodiment, the first wing member further has a first pivoting connection portion, the first connecting rod member further has a first pivoting head column and a first pivoting tail column, and the first pivoting head column and the first pivoting tail column respectively extend along the first rotation axis and are formed on opposite sides of the first rod body, to be correspondingly pivoted on the first pivoting connection portion, such that the first rod body is able to pivot relative to the first wing member with the first rotation axis as a center. And the second wing member further has a second pivoting connection portion, the second connecting rod member further has a second pivoting head column and a second pivoting tail column, and the second pivoting head column and the second pivoting tail column respectively extend along the second rotation axis and are formed on opposite sides of the second rod body, to be correspondingly pivoted on the second pivoting connection portion, such that the second rod body is able to pivot relative to the second wing member with the second rotation axis as a center.

In one embodiment, the first pivoting connection portion has a first abutting plane, and the first rod body has a first inner section, a first middle section and a first outer section that are sequentially connected. The first inner section is adjacent to the first shaft relative to the first outer section, and the first pivoting head column and the first pivoting tail column are formed on the first middle section. In the unfolded state, the first outer section abuts against the first abutting plane. The second pivoting connection portion has a second abutting plane, and the second rod body has a second inner section, a second middle section and a second outer section that are sequentially connected. The second inner section is adjacent to the second shaft relative to the second outer section, the second pivoting head column and the second pivoting tail column are formed on the second middle section. In the unfolded state, the second outer section abuts against the second abutting plane.

In one embodiment, in the half-open state, the first outer section does not contact with the first abutting plane, the first driving member does not contact with the first wing member, the second outer section does not contact with the second abutting plane, and the second driving member does not contact with the second wing member. In the folded state, the first outer section does not contact with the first abutting plane, the first driving member abuts against the first wing member, the second outer section does not contact with the second abutting plane, and the second driving member abuts against the second wing member.

In one embodiment, the first rod body has a first inner surrounding surface, and the first inner surrounding surface surrounds the first driving member for restricting the first driving member to slide only along the first straight sliding groove, so that the first connecting rod member pivots synchronously with the first driving member. The second rod body has a second inner surrounding surface, and the second inner surrounding surface surrounds the second driving member for restricting the second driving member to slide only along the second straight sliding groove, so that the second connecting rod member pivots synchronously with the second driving member.

In one embodiment, the first front arc-shaped groove defines a first virtual axis parallel to the first axis, and the first wing member rotates relative to the main portion about the first virtual axis. The second front arc-shaped groove defines a second virtual axis parallel to the second axis, and the second wing member rotates relative to the main portion about the second virtual axis.

In one embodiment, the first wing member further has a first rear arc-shaped block, the second wing member further has a second rear arc-shaped block, and the central base further has a first rear arc-shaped groove and a second rear arc-shaped groove formed oppositely in the main portion. The first virtual axis passes through the first rear arc-shaped groove, and the first rear arc-shaped block is rotatably disposed in the first rear arc-shaped groove. The second virtual axis passes through the second rear arc-shaped groove, and the second rear arc-shaped block is rotatably disposed in the second rear arc-shaped groove.

In one embodiment, the elastic module further includes a third elastic member disposed between the first elastic member and the second elastic member. Each of the first elastic member, the second elastic member and the third elastic member is a compression spring abutting against the abutting member and the fixed seat.

In one embodiment, in the unfolded state, the first driving member and the second driving member are correspondingly angled at about 180 degrees, the first connecting rod member and the second connecting rod member are correspondingly angled at about 180 degrees, and the first wing member and the second wing member are correspondingly angled at about 180 degrees, substantially. In the half-open state, the first driving member and the second driving member are correspondingly angled at an obtuse angle, the first connecting rod member and the second connecting rod member are correspondingly angled at an obtuse angle, and the first wing member and the second wing member are correspondingly angled at an obtuse angle, substantially. In the folded state, the first driving member and the second driving member are correspondingly angled at an acute angle, the first connecting rod member and the second connecting rod member are correspondingly angled at an acute angle, and the first wing member and the second wing member are correspondingly angled at a negatively acute angle, substantially.

In one embodiment, the first pivoting connection portion has a first head seat and a first tail seat spaced apart from each other, and the first pivoting head column is pivotally inserted into the first head seat and the first pivoting tail column is pivotally inserted into the first tail seat. The second pivoting connection portion has a second head seat and a second tail seat spaced apart from each other, and the second pivoting head column is pivotally inserted into the second head seat and the second pivoting tail column is pivotally inserted into the second tail seat.

In one embodiment, in the unfolded state, the first driving member substantially occupies the first straight sliding groove in whole, and the second driving member substantially occupies the second straight sliding groove in whole. In the folded state, the first driving member approximately occupies the first straight sliding groove in half, and the second driving member approximately occupies the second straight sliding groove in half.

In one embodiment, the synchronous pivot module further includes a first gear, a second gear and an even number of intermediate gears, the first gear is rotatably fitted onto the first shaft, the second gear is rotatably fitted onto the second shaft, and the intermediate gears, disposed between the first gear and the second gear, mesh with each other and respectively mesh with the first gear and the second gear, thereby enabling the first gear and the second gear to rotate synchronously and reversely.

In one embodiment, the first driving member has a first hollow column and a first extension plate that are interconnected, the first hollow column is provided for the first shaft to penetrate, and the first extension plate is slidably inserted into the first straight sliding groove. The second driving member has a second hollow column and a second extension plate that are interconnected, the second hollow column is provided for the second shaft to penetrate, and the second extension plate is slidably inserted into the second straight sliding groove.

In one embodiment, the first driving member further has a first driving cam formed on the first hollow column, the second driving member further has a second driving cam formed on the second hollow column, and the abutting member has a first driven cam fitting with the first driving cam and a second driven cam fitting with the second driving cam. In the half-open state, the first driving cam and the second driving cam push away the first driven cam and the second driven cam respectively, so as to compress the first elastic member and the second elastic member, which makes the total elastic force relatively higher. In the unfolded state or the folded state, the first elastic member and the second elastic member are released, which makes the total elastic force relatively lower.

In one embodiment, the foldable electronic device further comprises a support plate unit, and the support plate unit includes a main support plate, which is disposed on the central base and positioned between the elastic module and the flexible screen.

After referring drawings and embodiments described below, a person skilled in the art will well appreciate other objectives of the present invention, as well as means and implemented modes of the present invention.

### BRIEF DESCRIPTION OF THE DRAWINGS

FIG. 1 is a partially exploded view of a foldable electronic device in an unfolded state according to the present invention;

FIG. 2 is another partially exploded view of the foldable electronic device in the unfolded state according to the present invention;

FIG. 3 is an exploded view of some components of the foldable electronic device in the unfolded state according to the present invention;

FIG. 4 is another exploded view of the components of the foldable electronic device in the unfolded state according to the present invention;

FIG. 5 is a schematic view of a central base, a synchronous pivot module, a first operating module, a second operating module and an elastic module of the foldable electronic device in the unfolded state according to the present invention;

FIG. 6 is a reversely schematic view of FIG. 5;

FIG. 7 is a partially exploded view of FIG. 5;

FIG. 8 is another partially exploded view of FIG. 5;

FIG. 9 is a cross-sectional view along a segment A-A′ as shown in FIG. 1;

FIG. 10 is a cross-sectional view of FIG. 9 after being changed to a half-open state;

FIG. 11 is a cross-sectional view of FIG. 10 after being changed to a folded state;

FIG. 12 is a cross-sectional view along a segment B-B′ as shown in FIG. 1 after being changed to a U-shaped folded state.

### DETAILED DESCRIPTION OF THE PREFERRED EMBODIMENT

Reference will now be made in detail to the present embodiments of the invention, examples of which are illustrated in the accompanying drawings, and are not intended to limit the present invention, applications or particular implementations described in these embodiments. Wherever possible, the same reference numbers are used in the drawings and the description to refer to the same or like parts. It shall be appreciated that, in the following embodiments and the attached drawings, elements unrelated to the present invention are omitted from depiction; and dimensional relationships among individual elements in the attached drawings are provided only for ease of understanding, but not to limit the actual scale.

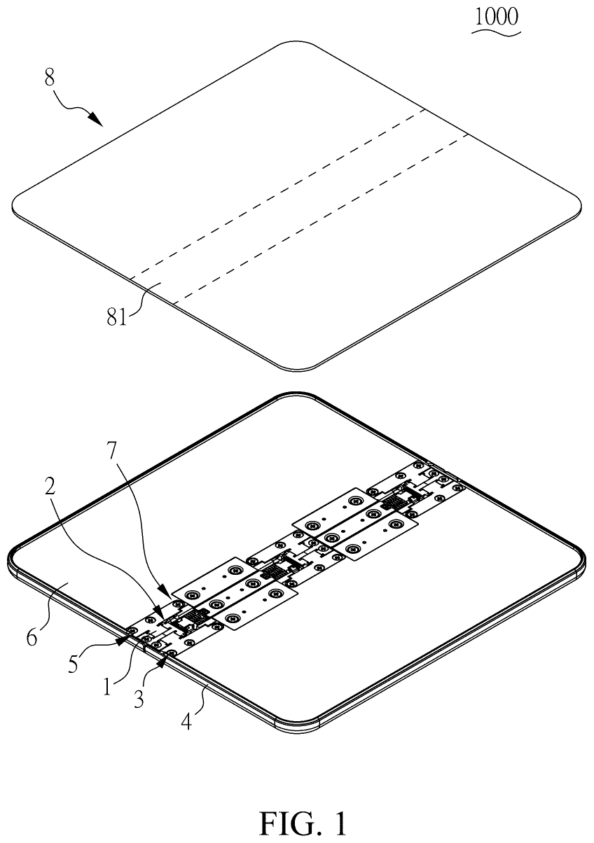

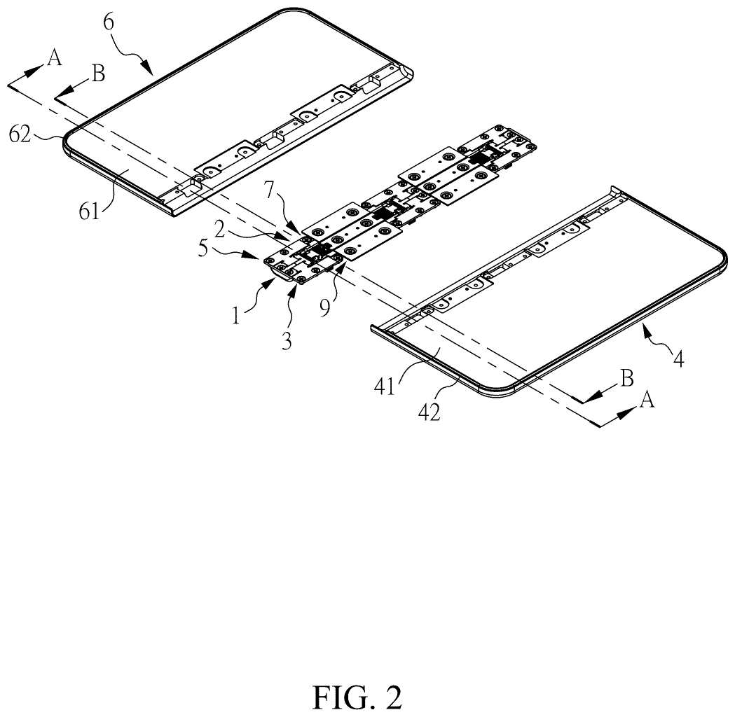

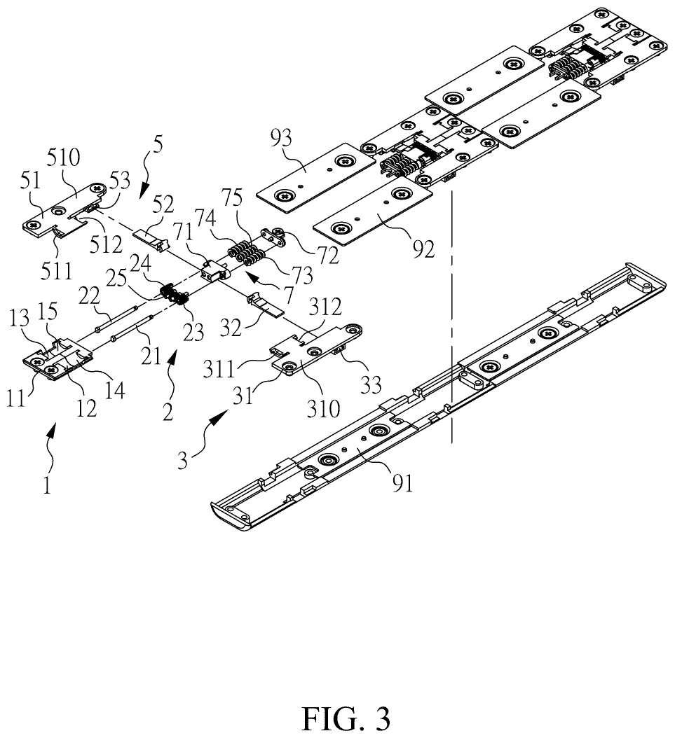

Please refer to FIG. 1, FIG. 2 and FIG. 3. A foldable electronic device 1000 of the present invention comprises a central base 1, a synchronous pivot module 2, a first operating module 3, a first panel unit 4, a second operating module 5, a second panel unit 6, an elastic module 7, a flexible screen 8 and a support plate unit 9. The synchronous pivot module 2 is arranged in the central base 1. The first operating module 3 and second operating module 5 are connected to opposite sides of the synchronous pivot module 2 and are fixedly connected to the first panel unit 4 and second panel unit 6, respectively. The elastic module 7 is disposed in the central base 1 and linked with the synchronous pivot module 2. The flexible screen 8 is arranged on the first panel unit 4 and second panel unit 6 and covers the central base 1. The support plate unit 9 is positioned beneath the flexible screen 8 to provide a supporting effect. Meanwhile, the synchronous pivot module 2, the first operating module 3, the second operating module 5, the elastic module 7, and the support plate unit 9 form a mechanism assembly (not numbered in figures). The mechanism assembly may be one or multiple sets. For simplicity, the following description will only focus on one set for detailing structures of components and their interconnections.

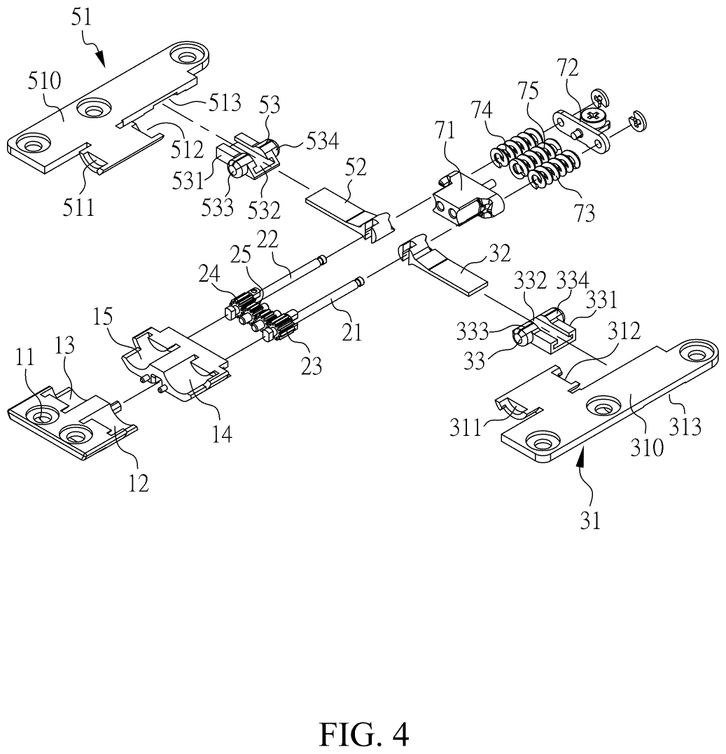

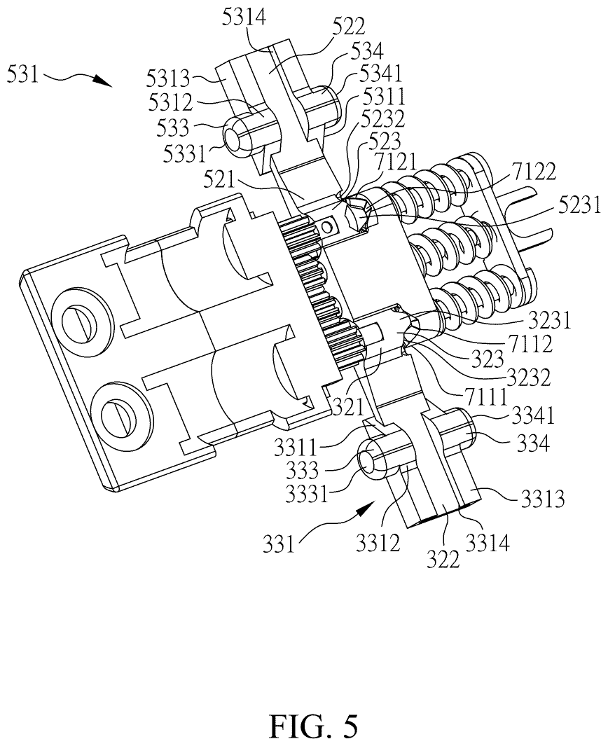

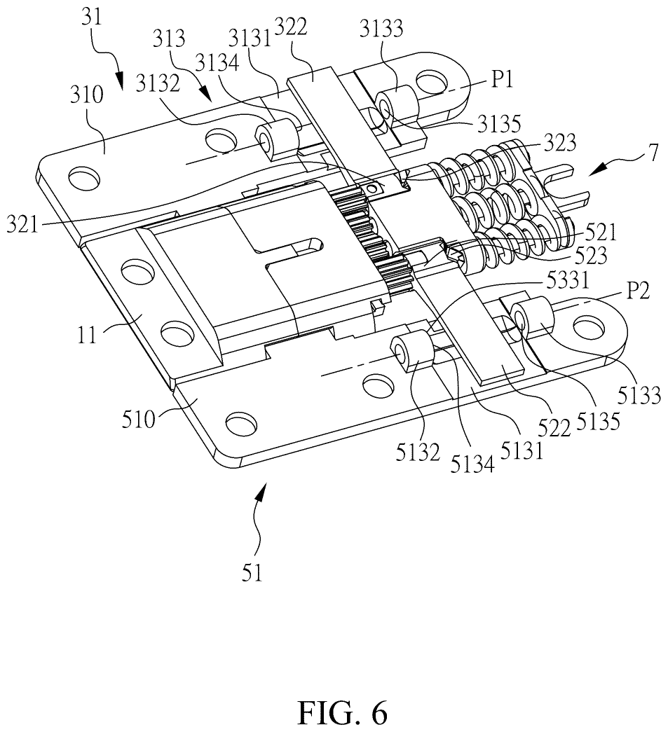

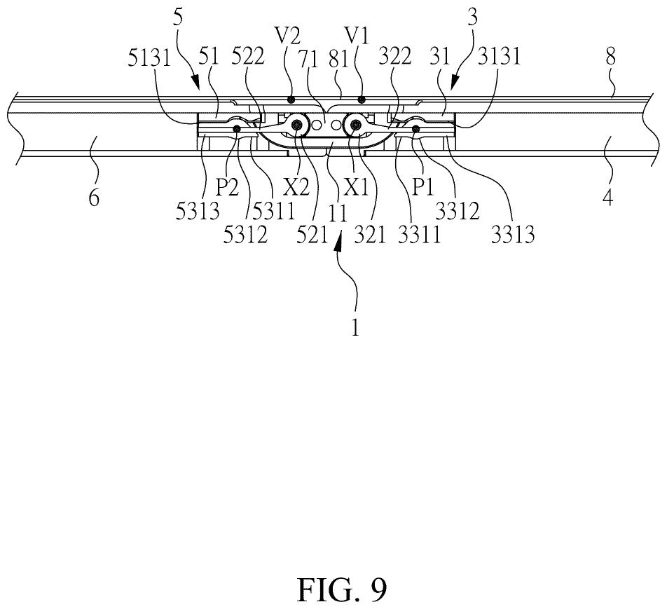

Also referring to FIG. 4, FIG. 5 and FIG. 6, the central base 1 includes a main portion 11, a first front arc-shaped groove 12, a second front arc-shaped groove 13, a first rear arc-shaped groove 14 and a second rear arc-shaped groove 15. The first front arc-shaped groove 12 and the first rear arc-shaped groove 14 are approximately arranged in a linear way on the main portion 11, and together define a first virtual axis V1 (as shown in FIG. 9). The second front arc-shaped groove 13 and the second rear arc-shaped groove 15 are approximately arranged in a linear way on the main portion 11, and together define a second virtual axis V2 (as shown in FIG. 9).

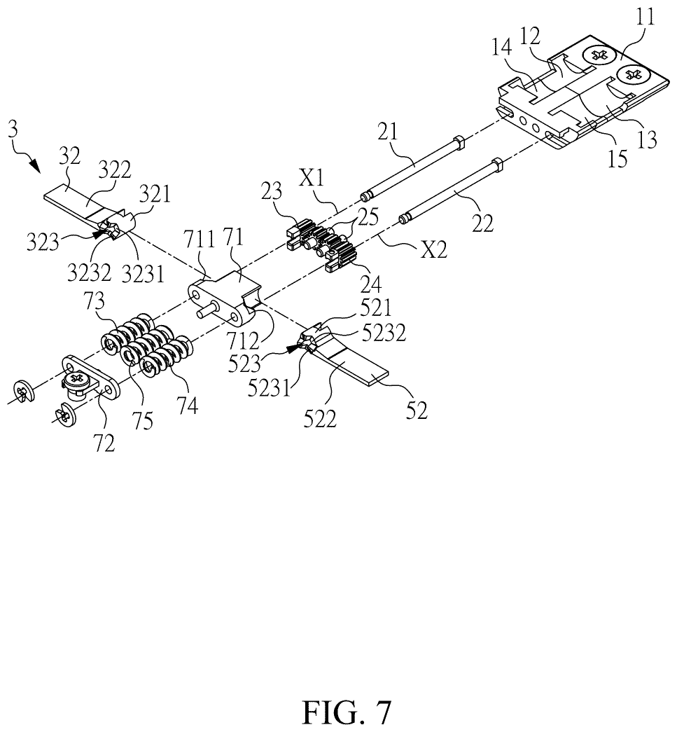

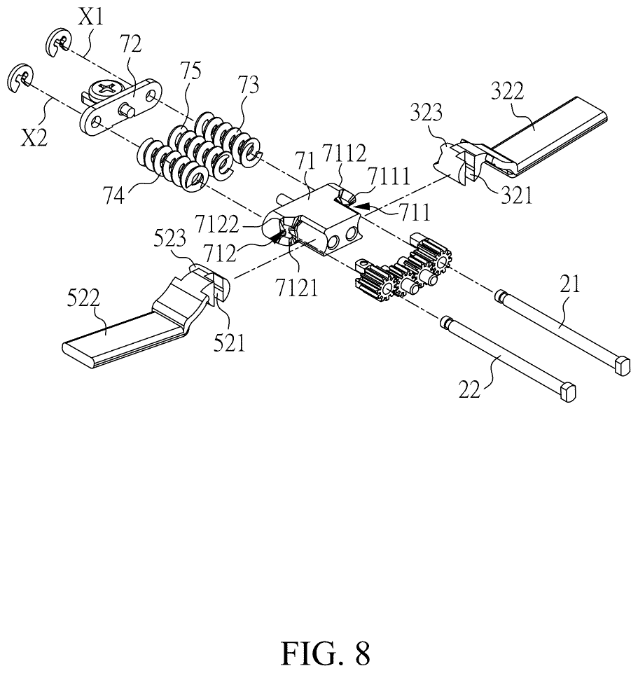

Further referring to FIG. 7 and FIG. 8, the synchronous pivot module 2 is accommodated in the central base 1 and includes a first shaft 21, a second shaft 22, a first gear 23, a second gear 24 and two intermediate gears 25. The first shaft 21 and the second shaft 22 are respectively passed through the main portion 11 along a first axis X1 and a second axis X2. The first gear 23 is rotatably sleeved on the first shaft 21 and positioned near the main portion 11, while the second gear 24 is rotatably sleeved on the second shaft 22 and positioned near the main portion 11. The intermediate gears 25 mesh with each other and are positioned between the first gear 23 and the second gear 24, and respectively mesh with the first gear 23 and the second gear 24. The number of intermediate gears 25 must be an even number, which allows the first gear 23 and the second gear 24 to rotate synchronously in reverse. Additionally, the first axis X1, the second axis X2, the first virtual axis V1 and the second virtual axis V2 are all parallel to each other.

The first operating module 3 is connected to the synchronous pivot module 2 and includes a first wing member 31, a first driving member 32 and a first connecting rod member 33, as further explained below.

The first wing member 31 has a first elongated plate 310, a first front arc-shaped block 311, a first rear arc-shaped block 312 and a first pivoting connection portion 313. The first elongated plate 310 roughly extends parallel to the first virtual axis V1. The first front arc-shaped block 311 and the first rear arc-shaped block 312 protrude from one side, near the main portion 11, of the first elongated plate 310. The first pivoting connection portion 313 is disposed on a surface (not numbered in the figures), away from the flexible screen 8, of the first elongated plate 310. The first front arc-shaped block 311 is rotatably disposed in the first front arc-shaped groove 12, and the first rear arc-shaped block 312 is rotatably disposed in the first rear arc-shaped groove 14, allowing the first wing member 31 to pivot relative to the main portion 11 about the first virtual axis V1. Referring to FIG. 6 (with the first connecting rod member 33 omitted) again, the first pivoting connection portion 313 has a first abutting plane 3131, a first head seat 3132, a first tail seat 3133, a first head groove 3134, and a first tail groove 3135. The first head seat 3132 and the first tail seat 3133 are spaced apart from each other and respectively adjacent to opposite sides of the first abutting plane 3131. The first head groove 3134 is formed in the first head seat 3132, and the first tail groove 3135 is formed in the first tail seat 3133.

The first driving member 32 is rotatably sleeved on the first shaft 21 and rotates synchronously with the first gear 23, which has a first hollow column 321, a first extension plate 322 and a first driving cam 323. The first hollow column 321 is penetrated by the first shaft 21 and is fixedly connected to the first gear 23 (for example, through a tenon-mortise fixing). The first extension plate 322 connects the first hollow column 321 and extends outward in a direction substantially perpendicular to the first axis X1. The first driving cam 323 is formed at one end, away from the main portion 11, of the first hollow column 321. In other words, the first driving cam 323 is an end cam. Additionally, the first driving cam 323 has a plurality of first driving teeth 3231 and a plurality of first driving recesses 3232 that are alternately arranged in a surrounding manner.

The first connecting rod member 33 has a first rod body 331, a first straight sliding groove 332, a first pivoting head column 333 and a first pivoting tail column 334. The first rod body 331 is pivotally disposed on the first pivoting connection portion 313 of the first wing member 31 about a first rotation axis P1, which is substantially parallel to the first axis X1. The first straight sliding groove 332 is formed in the first rod body 331 and extends substantially perpendicular to the first axis X1, for the first extension plate 322 of the first driving member 32 to slidably insert therein. The first pivoting head column 333 and the first pivoting tail column 334 extend along the first rotation axis P1 and are formed on opposite sides of the first rod body 331, and are respectively pivoted on the first pivoting connection portion 313, so that the first rod body 331 is able to pivot relative to the first wing member 31 about the first rotation axis P1. Moreover, the first pivoting head column 333 has a first head spherical portion 3331, and the first pivoting tail column 334 has a first tail spherical portion 3341. The first head spherical portion 3331 is rotatably fitting with the first head groove 3134 (or a ball-joint connection), and the first tail spherical portion 3341 is rotatably fitting with the first tail groove 3135 (or a ball-joint connection), which enables the first rod body 331 of the first connecting rod member 33 to pivot relative to the first pivoting connection portion 313 of the first wing member 31. But the pivoting way is not limited thereto. For example, it could also be achieved through two separate shafts, which will not be further described here.

Specifically, the first rod body 331 has a first inner section 3311, a first middle section 3312 and a first outer section 3313, which are sequentially connected. The first inner section 3311 is positioned near the first shaft 21, relative to the first outer section 3313. The first pivoting head column 333 and the first pivoting tail column 334 are formed on opposite sides of the first middle section 3312. Moreover, the first rod body 331 further has a first inner surrounding surface 3314, which defines the first straight sliding groove 332. And, the first inner surrounding surface 3314 surrounds the first extension plate 322 of the first driving member 32 (that is, four sides being limited), to restrict the first extension plate 322 to slide) only along a direction of the first straight sliding groove 332 (that is, an extension direction of the first straight sliding groove 332), ensuring that the first connecting rod member 33 and the first driving member 32 pivot synchronously.

It is particularly noted that the first connecting rod member 33 is pivoted on the first pivoting connection portion 313 of the first wing member 31 through the first pivoting head column 333 and the first pivoting tail column 334 (located on the first middle section 3312 of the first rod body 331), and in other words, the first connecting rod member 33 is centrally pivoted on the first wing member 31. As a result, the first connecting rod member 33 is able to perform a seesaw motion relative to the first wing member 31. This design enhances stabilities and lifespans of relative components and reduces an overall volume of the first operating module 3.

The first panel unit 4 includes a first main body 41 and a first outer casing 42. The first wing member 31 of the first operating module 3 is fixedly connected (for example, by screw fastening) to one side edge of the first main body 41 (near the main portion 11). Thus, the first panel unit 4 is capable of pivoting relative to the main portion 11 of the central base 1 about the first virtual axis V1, synchronously with the first wing member 31. On the other hand, the first panel unit 4 also includes electronic components, but those are not directly related to foldable operating and will not be further discussed here.

Similarly, the second operating module 5 is connected to the synchronous pivot module 2 and includes a second wing member 51, a second driving member 52 and a second connecting rod member 53, as further explained below.

The second wing member 51 has a second elongated plate 510, a second front arc-shaped block 511, a second rear arc-shaped block 512 and a second pivoting connection portion 513. The second elongated plate 510 roughly extends parallel to the first virtual axis V2. The second front arc-shaped block 511 and the second rear arc-shaped block 512 protrude from one side, near the main portion 11, of the second elongated plate 510. The second pivoting connection portion 513 is disposed on a surface (not numbered in the figures), away from the flexible screen 8, of the second elongated plate 510. The second front arc-shaped block 511 is rotatably disposed in the second front arc-shaped groove 13, and the second rear arc-shaped block 312 is rotatably disposed in the second rear arc-shaped groove 15, allowing the second wing member 51 to pivot relative to the main portion 11 about the second virtual axis V2. Referring to FIG. 6 (with the second connecting rod member 53 omitted) again, the second pivoting connection portion 513 has a second abutting plane 5131, a second head seat 5132, a second tail seat 5133, a second head groove 5134, and a second tail groove 5135. The second head seat 5132 and the second tail seat 5133 are spaced apart from each other and respectively adjacent to opposite sides of the second abutting plane 5131. The second head groove 5134 is formed in the second head seat 5132, and the second tail groove 5135 is formed in the second tail seat 5133.

The second driving member 52 is rotatably sleeved on the second shaft 22 and rotates synchronously with the second gear 24, which has a second hollow column 521, a second extension plate 522 and a second driving cam 523. The second hollow column 521 is penetrated by the second shaft 22 and is fixedly connected to the second gear 24 (for example, through a tenon-mortise fixing). The second extension plate 522 connects the second hollow column 521 and extends outward in a direction substantially perpendicular to the second axis X1. The second driving cam 523 is formed at one end, away from the main portion 11, of the second hollow column 521. In other words, the second driving cam 523 is an end cam. Additionally, the second driving cam 523 has a plurality of second driving teeth 5231 and a plurality of second driving recesses 5232 that are alternately arranged in a surrounding manner.

The second connecting rod member 53 has a second rod body 531, a second straight sliding groove 532, a second pivoting head column 533 and a second pivoting tail column 534. The second rod body 531 is pivotally disposed on the second pivoting connection portion 513 of the second wing member 51 about a second rotation axis P2, which is substantially parallel to the second axis X2. The second straight sliding groove 532 is formed in the second rod body 531 and extends substantially perpendicular to the second axis X2, for the second extension plate 522 of the second driving member 52 to slidably insert therein. The second pivoting head column 533 and the second pivoting tail column 534 extend along the second rotation axis P2 and are formed on opposite sides of the second rod body 531, and are respectively pivoted on the second pivoting connection portion 513, so that the second rod body 531 is able to pivot relative to the second wing member 51 about the second rotation axis P2. Moreover, the second pivoting head column 533 has a second head spherical portion 5331, and the second pivoting tail column 534 has a second tail spherical portion 5341. The second head spherical portion 5331 is rotatably fitting with the second head groove 5134 (or a ball-joint connection), and the second tail spherical portion 5341 is rotatably fitting with the second tail groove 5135 (or a ball-joint connection), which enables the second rod body 531 of the second connecting rod member 53 to pivot relative to the second pivoting connection portion 513 of the second wing member 51. But the pivoting way is not limited thereto. For example, it could also be achieved through two separate shafts, which will not be further described here.

Specifically, the second rod body 531 has a second inner section 5311, a second middle section 5312 and a second outer section 5313, which are sequentially connected. The second inner section 5311 is positioned near the second shaft 22, relative to the second outer section 5313. The second pivoting head column 533 and the second pivoting tail column 534 are formed on opposite sides of the second middle section 5312. Moreover, the second rod body 531 further has a second inner surrounding surface 5314, which defines the second straight sliding groove 532. And the second inner surrounding surface 5314 surrounds the second extension plate 522 of the second driving member 52 (that is, four sides being limited), to restrict the second extension plate 522 to slide only along a direction of the second straight sliding groove 532 (that is, an extension direction of the second straight sliding groove 532), ensuring that the second connecting rod member 53 and the second driving member 52 pivot synchronously.

It is particularly noted that the second connecting rod member 53 is pivoted on the second pivoting connection portion 513 of the second wing member 51 through the second pivoting head column 533 and the second pivoting tail column 534 (located on the second middle section 5312 of the second rod body 531), and in other words, the second connecting rod member 53 is centrally pivoted on the second wing member 51. As a result, the second connecting rod member 53 is able to perform a seesaw motion relative to the second wing member 51. This design enhances stabilities and lifespans of relative components and reduces an overall volume of the second operating module 5.

The second panel unit 6 includes a second main body 61 and a second outer casing 62. The second wing member 51 of the second operating module 5 is fixedly connected (for example, by screw fastening) to one side edge of the second main body 61 (near the main portion 11). Thus, the second panel unit 6 is capable of pivoting relative to the main portion 11 of the central base 1 about the second virtual axis V2, synchronously with the second wing member 51. On the other hand, the second panel unit 6 also includes electronic components, but those are not directly related to foldable operating and will not be further discussed here.

The elastic module 7 is accommodated within the central base 1 and constantly provides a total elastic force to the first driving member 32 and second driving member 52. The elastic module 7 includes an abutting member 71, a fixed seat 72, a first elastic member 73, a second elastic member 74 and a third elastic member 75. The abutting member 71 is slidably sleeved on the first shaft 21 and the second shaft 22, and is movably engaged with the first driving member 32 and the second driving member 52. The fixed seat 72 is fixed to the first shaft 21 and second shaft 22. The first elastic member 73 is sleeved on the first shaft 21, the second elastic member 74 is sleeved on the second shaft 22, and the third elastic member 75 is disposed between the first elastic member 73 and the second elastic member 74. The first elastic member 73, the second elastic member 74 and the third elastic member 75 are respectively connected to the abutting member 71 and the fixed seat 72. In this embodiment, the first elastic member 73, the second elastic member 74 and the third elastic member 75 are each a compression spring, with both ends respectively abutting against the abutting member 71 and the fixed seat 72.

Furthermore, the abutting member 71 has a first driven cam 711 engaging with the first driving cam 323 and a second driven cam 712 engaging with the second driving cam 523. Specifically, the first driven cam 711 is hollow and sleeved on the first shaft 21, and has a plurality of first driven teeth 7111 and a plurality of first driven recesses 7112 alternately arranged in a surrounding manner (that is, an end cam). The second driven cam 712 is hollow and sleeved on the second shaft 22, and has a plurality of second driven teeth 7121 and a plurality of second driven recesses 7122 alternately arranged in a surrounding manner (that is, an end cam).

The flexible screen 8 is arranged on the central base 1, the first operating module 3, the first panel unit 4, the second operating module 5 and the second panel unit 6, and includes a bending area 81, which approximately corresponds to the central base 1.

The support plate unit 9 is arranged beneath the flexible screen 8 and includes a main support plate 91, a first support plate 92 and a second support plate 93. By such as screw fastening, the main support plate 91 is disposed on the central base 1, the first support plate 92 is disposed on the first panel unit 4, and the second support plate 93 is disposed on the second panel unit 6, thereby providing a supporting effect for the flexible screen 8 (particularly for the bending area 81).

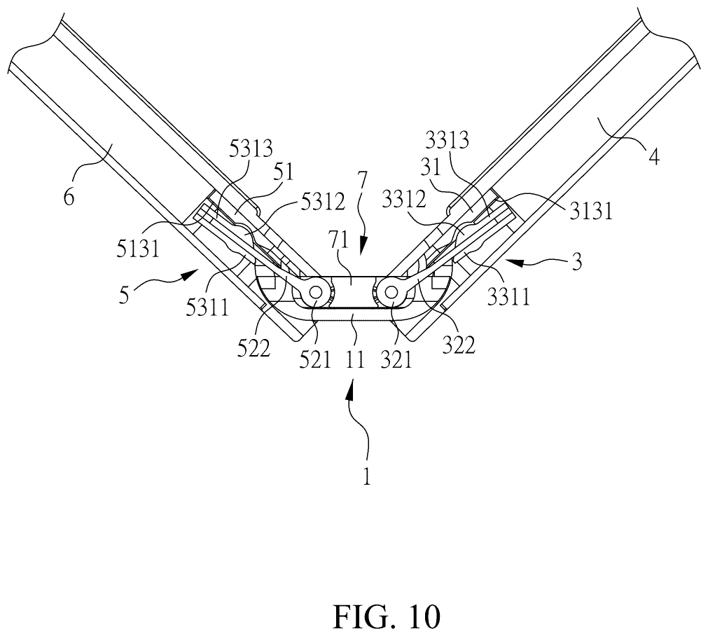

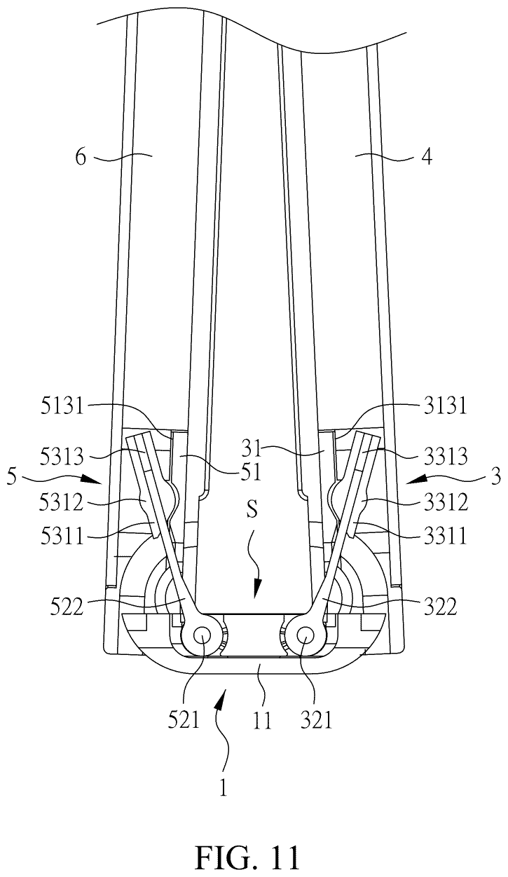

The following describes the detailed operation of the present invention. The foldable electronic device 1000 of the present invention is able to change between an unfolded state (e.g., as shown in FIG. 9), a half-open state (e.g., as shown in FIG. 10) and a folded state (e.g., as shown in FIG. 11). The half-open state is between the unfolded state and the folded state. In this embodiment, the first panel unit 4 and the second panel unit 6 are correspondingly angled at about 180 degrees, 90 degrees and 0 degree respectively for the unfolded state, the half-open state and the folded state.

In the unfolded state, the flexible screen 8 is flattened. The main portion 11, the first wing member 31, the second wing member 51, the main support plate 91, the first support plate 92, the second support plate 93 and the abutting member 71 together support the foldable area 81. The first outer section 3313 is in contact with the first abutting plane 3131, and the second outer section 5313 is in contact with the second abutting plane 5131. The first extension plate 322 of the first driving member 32 and the second extension plate 522 of the second driving member 52 are correspondingly angled at about 180 degrees, the first rod body 331 of the first connecting rod member 33 and the second rod body 531 of the second connecting rod member 53 are correspondingly angled at about 180 degrees, and the first elongated plate 310 of the first wing member 31 and the second elongated plate 510 of the second wing member 51 are also correspondingly angled at about 180 degrees. Meanwhile, the first driving member 32 occupies the first straight sliding groove 332 substantially in whole, and the second driving member 52 occupies the second straight sliding groove 532 substantially in whole. At this point, the first driving cam 323 and the first driven cam 711 are in a complementary engagement (concave-convex engagement), and the second driving cam 523 and the second driven cam 712 are also in a complementary engagement. In other words, the first driving teeth 3231 are correspondingly accommodated in the first driven recesses 7112, the first driven teeth 7111 are correspondingly accommodated in the first driving recesses 3232, the second driving teeth 5231 are correspondingly accommodated in the second driven recesses 7122, and the second driven teeth 7121 are correspondingly accommodated in the second driving recesses 5232. As a result, the first elastic member 73, the second elastic member 74 and the third elastic member 75 are released accordingly, causing the total elastic force to be relatively lower.

In the half-open state, the bendable area 81 of the flexible screen 8 is partially bent. The first outer section 3313 does not contact with the first abutting plane 3131, and the first driving member 32 does not contact with the first wing member 31. The second outer section 5313 does not contact with the second abutting plane 5131, and the second driving member 52 does not contact with the second wing member 51. The first extension plate 322 of the first driving member 32 and the second extension plate 522 of the second driving member 52 are correspondingly angled at an obtuse angle, the first rod body 331 of the first connecting rod member 33 and the second rod body 531 of the second connecting rod member 53 are correspondingly angled at an obtuse angle, and the first elongated plate 310 of the first wing member 31 and the second elongated plate 510 of the second wing member 51 are correspondingly angled at an obtuse angle. Meanwhile, the first driving member 32 occupies the first straight sliding groove 332 approximately in three quarters (75%), and the second driving member 52 occupies the second straight sliding groove 532 approximately in three quarters (75%). At this point, the first driving cam 323 and the first driven cam 711 are in a mutual repulsion engagement (either convex-convex engagement or concave-concave engagement), and the second driving cam 523 and the second driven cam 712 are also in a mutual repulsion engagement. In other words, the first driving cam 323 pushes the first driven cam 711 away, and the second driving cam 523 pushes the second driven cam 712 away. Specifically, the first driving teeth 3231 correspondingly abut against the first driven teeth 7111, the first driving recesses 3232 are positioned corresponding to the first driven recesses 7112, the second driving teeth 5231 correspondingly abut against the second driven teeth 7121, and the second driving recesses 5232 are positioned corresponding to the second driven recesses 7122. As a result, the first elastic member 73, the second elastic member 74 and the third elastic member 75 are compressed accordingly, causing the total elastic force to be relatively higher.

In the folded state, the bendable area 81 of the flexible screen 8 is more bent, forming a shape similar to a water droplet in cross-section. The first wing member 31, the second wing member 51 and the central base 1 together define an accommodation space S to accommodate the bendable area 81. The first outer section 3313 does not contact with the first abutting plane 3131, and the first driving member 32 abuts against the first wing member 31. The second outer section 5313 does not contact with the second abutting plane 5131, and the second driving member 52 abuts against the second wing member 51. The first extension plate 322 of the first driving member 32 and the second extension plate 522 of the second driving member 52 are correspondingly angled at an acute angle, the first rod body 331 of the first connecting rod member 33 and the second rod body 531 of the second connecting rod member 53 are correspondingly angled at an acute angle, and the first elongated plate 310 of the first wing member 31 and the second elongated plate 510 of the second wing member 51 are correspondingly angled at an acute angle (but relatively negative). Meanwhile, the first driving member 32 occupies the first straight sliding groove 332 approximately in half (½), and the second driving member 52 occupies the second straight sliding groove 532 approximately in half (½). At this point, the first driving cam 323 and the first driven cam 711 return to the complementary engagement (concave-convex engagement), and the second driving cam 523 and the second driven cam 712 also return to the complementary engagement. As a result, the first elastic member 73, the second elastic member 74 and the third elastic member 75 are released accordingly, causing the total elastic force to be relatively lower again.

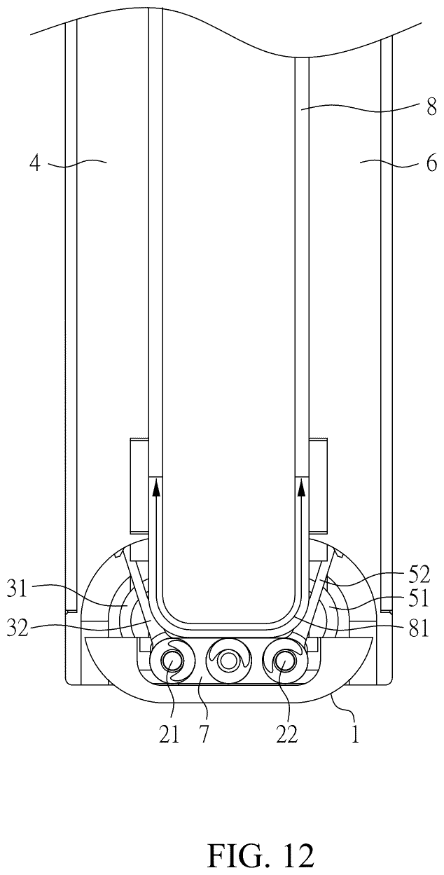

To add further clarification, if the foldable electronic device 1000 is applied in double-folding, a folded state is shown in FIG. 12. Namely, a U-shaped folded state essentially forms (i.e., the first panel unit and the second panel unit extend substantially parallel to each other), to allow a third panel unit (not shown in the figure) to be sandwiched therein.

In summary, for the foldable electronic device of this invention, the first connecting rod member 33 is centrally pivoted on the first wing member 31 and the second connecting rod member 53 is centrally pivoted on the second wing member 51 respectively, in combination with the first driving member 32 and the second driving member 52, so as to enhance the stabilities and lifespans of the components and to reduce the overall volume.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A foldable electronic device, comprising:
a central base, including a main portion, a first front arc-shaped groove and a second front arc-shaped groove, wherein the first front arc-shaped groove and the second front arc-shaped groove are formed oppositely in the main portion;
a synchronous pivot module, disposed in the central base, and including a first shaft and a second shaft respectively penetrating through the main portion, wherein the first shaft extends along a first axis and the second shaft extends along a second axis;
a first operating module, connected to the synchronous pivot module, and including
a first wing member, having a first front arc-shaped block, wherein the first front arc-shaped block is rotatably disposed in the first front arc-shaped groove, so that the first wing member is able to pivot relative to the main portion,
a first driving member, sleeved on the first shaft and capable of rotating relative to the first shaft around the first axis, and
a first connecting rod member, having a first rod body and a first straight sliding groove formed in the first rod body, wherein the first rod body is pivoted on the first wing member along a first rotation axis substantially parallel to the first axis, and wherein the first straight sliding groove extends substantially perpendicular to the first axis for the first driving member to slide and to insert therein,
a first panel unit, connected to and capable of rotating synchronously with the first wing member;
a second operating module, connected to the synchronous pivot module, and including
a second wing member, having a second front arc-shaped block, wherein the second front arc-shaped block is rotatably disposed in the second front arc-shaped groove, so that the second wing member is able to pivot relative to the main portion,
a second driving member, sleeved on the second shaft and capable of rotating relative to the second shaft around the second axis, and
a second connecting rod member, having a second rod body and a second straight sliding groove formed in the second rod body, wherein the second rod body is pivoted on the second wing member along a second rotation axis substantially parallel to the second axis, and wherein the second straight sliding groove extends substantially perpendicular to the second axis for the second driving member to slide and to insert therein,
a second panel unit, connected to and capable of rotating synchronously with the first second member;
an elastic module, disposed in the central base and constantly providing a total elastic force to the first driving member and second driving member, and having an abutting member, a fixed seat, a first elastic member and a second elastic member, wherein the abutting member is slidably sleeved on the first shaft and second shaft and is movably engaged with the first driving member and the second driving member, the fixed seat is fixed to the first shaft and second shaft, the first elastic member is sleeved on the first shaft, the second elastic member is sleeved on the second shaft, and the first elastic member and the second elastic member are respectively connected to the abutting member and the fixed seat respectively; and
a flexible screen arranged on the central base, the first operating module, the first panel unit, the second operating module and the second panel unit, and including a bendable area;
wherein the first panel unit and second panel unit are capable of changing between an unfolded state, a half-open state and a folded state, and the half-open state is between the unfolded state and the folded state, wherein when the first panel unit and the second panel unit are in the unfolded state, the flexible screen is flattened, and the first wing member and the second wing member jointly support the bendable area, and wherein when the first panel unit and the second panel unit are in the folded state, the bendable area of the flexible screen bends, and the first wing member, the second wing member and the central base jointly define an accommodating space for accommodating the bendable area.

2. The foldable electronic device as claimed in claim 1, wherein the first connecting rod member is centrally pivoted on the first wing member and is capable of performing a seesaw motion relative to the first wing member, and the second connecting rod member is centrally pivoted on the second wing member and is capable of performing a seesaw motion relative to the second wing member.

3. The foldable electronic device as claimed in claim 2, wherein the first wing member further has a first pivoting connection portion, the first connecting rod member further has a first pivoting head column and a first pivoting tail column, and the first pivoting head column and the first pivoting tail column respectively extend along the first rotation axis and are formed on opposite sides of the first rod body, to be correspondingly pivoted on the first pivoting connection portion, such that the first rod body is able to pivot relative to the first wing member with the first rotation axis as a center, and wherein the second wing member further has a second pivoting connection portion, the second connecting rod member further has a second pivoting head column and a second pivoting tail column, and the second pivoting head column and the second pivoting tail column respectively extend along the second rotation axis and are formed on opposite sides of the second rod body, to be correspondingly pivoted on the second pivoting connection portion, such that the second rod body is able to pivot relative to the second wing member with the second rotation axis as a center.

4. The foldable electronic device as claimed in claim 3, wherein the first pivoting connection portion has a first abutting plane, and the first rod body has a first inner section, a first middle section and a first outer section that are sequentially connected, the first inner section is adjacent to the first shaft relative to the first outer section, the first pivoting head column and the first pivoting tail column are formed on the first middle section, and the first outer section abuts against the first abutting plane in the unfolded state, and wherein the second pivoting connection portion has a second abutting plane, and the second rod body has a second inner section, a second middle section and a second outer section that are sequentially connected, the second inner section is adjacent to the second shaft relative to the second outer section, the second pivoting head column and the second pivoting tail column are formed on the second middle section, and the second outer section abuts against the second abutting plane in the unfolded state.

5. The foldable electronic device as claimed in claim 4, wherein, in the half-open state, the first outer section does not contact with the first abutting plane, the first driving member does not contact with the first wing member, the second outer section does not contact with the second abutting plane, and the second driving member does not contact with the second wing member, and wherein, in the folded state, the first outer section does not contact with the first abutting plane, the first driving member abuts against the first wing member, the second outer section does not contact with the second abutting plane, and the second driving member abuts against the second wing member.

6. The foldable electronic device as claimed in claim 5, wherein the first rod body has a first inner surrounding surface, and the first inner surrounding surface surrounds the first driving member for restricting the first driving member to slide only along the first straight sliding groove, so that the first connecting rod member pivots synchronously with the first driving member, and wherein the second rod body has a second inner surrounding surface, and the second inner surrounding surface surrounds the second driving member for restricting the second driving member to slide only along the second straight sliding groove, so that the second connecting rod member pivots synchronously with the second driving member.

7. The foldable electronic device as claimed in claim 6, wherein the first front arc-shaped groove defines a first virtual axis parallel to the first axis, and the first wing member rotates relative to the main portion about the first virtual axis, and wherein the second front arc-shaped groove defines a second virtual axis parallel to the second axis, and the second wing member rotates relative to the main portion about the second virtual axis.

8. The foldable electronic device as claimed in claim 7, wherein the first wing member further has a first rear arc-shaped block, the second wing member further has a second rear arc-shaped block, and the central base further has a first rear arc-shaped groove and a second rear arc-shaped groove formed oppositely in the main portion, wherein the first virtual axis passes through the first rear arc-shaped groove, and the first rear arc-shaped block is rotatably disposed in the first rear arc-shaped groove, and wherein the second virtual axis passes through the second rear arc-shaped groove, and the second rear arc-shaped block is rotatably disposed in the second rear arc-shaped groove.

9. The foldable electronic device as claimed in claim 8, wherein the elastic module further includes a third elastic member disposed between the first elastic member and the second elastic member, and wherein each of the first elastic member, the second elastic member and the third elastic member is a compression spring abutting against the abutting member and the fixed seat.

10. The foldable electronic device as claimed in claim 3, wherein, in the unfolded state, the first driving member and the second driving member are correspondingly angled at about 180 degrees, the first connecting rod member and the second connecting rod member are correspondingly angled at about 180 degrees, and the first wing member and the second wing member are correspondingly angled at about 180 degrees, substantially, wherein, in the half-open state, the first driving member and the second driving member are correspondingly angled at an obtuse angle, the first connecting rod member and the second connecting rod member are correspondingly angled at an obtuse angle, and the first wing member and the second wing member are correspondingly angled at an obtuse angle, substantially, and wherein, in the folded state, the first driving member and the second driving member are correspondingly angled at an acute angle, the first connecting rod member and the second connecting rod member are correspondingly angled at an acute angle, and the first wing member and the second wing member are correspondingly angled at a negatively acute angle, substantially.

11. The foldable electronic device as claimed in claim 10, wherein the first pivoting connection portion has a first head seat and a first tail seat spaced apart from each other, and the first pivoting head column is pivotally inserted into the first head seat and the first pivoting tail column is pivotally inserted into the first tail seat, and wherein the second pivoting connection portion has a second head seat and a second tail seat spaced apart from each other, and the second pivoting head column is pivotally inserted into the second head seat and the second pivoting tail column is pivotally inserted into the second tail seat.

12. The foldable electronic device as claimed in claim 11, wherein, in the unfolded state, the first driving member substantially occupies the first straight sliding groove in whole, and the second driving member substantially occupies the second straight sliding groove in whole, and wherein, in the folded state, the first driving member approximately occupies the first straight sliding groove in half, and the second driving member approximately occupies the second straight sliding groove in half.

13. The foldable electronic device as claimed in claim 12, wherein the synchronous pivot module further includes a first gear, a second gear and an even number of intermediate gears, the first gear is rotatably fitted onto the first shaft, the second gear is rotatably fitted onto the second shaft, and the intermediate gears, disposed between the first gear and the second gear, mesh with each other and respectively mesh with the first gear and the second gear, thereby enabling the first gear and the second gear to rotate synchronously and reversely.

14. The foldable electronic device as claimed in claim 13, wherein the first driving member has a first hollow column and a first extension plate that are interconnected, the first hollow column is provided for the first shaft to penetrate, and the first extension plate is slidably inserted into the first straight sliding groove, and wherein the second driving member has a second hollow column and a second extension plate that are interconnected, the second hollow column is provided for the second shaft to penetrate, and the second extension plate is slidably inserted into the second straight sliding groove.

15. The foldable electronic device as claimed in claim 14, wherein the first driving member further has a first driving cam formed on the first hollow column, the second driving member further has a second driving cam formed on the second hollow column, the abutting member has a first driven cam fitting with the first driving cam and a second driven cam fitting with the second driving cam, wherein, in the half-open state, the first driving cam and the second driving cam push away the first driven cam and the second driven cam respectively, so as to compress the first elastic member and the second elastic member, which makes the total elastic force relatively higher, and wherein, in the unfolded state or the folded state, the first elastic member and the second elastic member are released, which makes the total elastic force relatively lower.

16. The foldable electronic device as claimed in claim 15, further comprising a support plate unit, wherein the support plate unit includes a main support plate, which is disposed on the central base and positioned between the elastic module and the flexible screen.
